(19) United States
(12) Patent Application Publication
(10) Pub. No.: US 2005/0028992 A1
(43) Pub. Date: Feb. 10, 2005

(54) Implement mounting fixture

(76) Inventor: Todd K. Potter, Hanover, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 10/936,942

(22) Filed: Sep. 9, 2004

Related U.S. Application Data
(63) Continuation-in-part of application No. 10/424,321, filed on Apr. 28, 2003, now Pat. No. 6,796,384.

(51) Int. Cl. A01B 63/118

(52) U.S. Cl. 172/439

(57) ABSTRACT

The invention comprises an implement attachment unit for mounting an implement to a work machine. The implement attachment unit includes a frame having a hitch for inserting in a receiver tunnel of a work machine. A hydraulic cylinder extends from a lower portion of the frame to operate the implement attachment unit and lift and support an attached implement. Preferably, the implement attachment unit comprises a three point hitch.

### CROSS REFERENCE TO RELATED APPLICATIONS

This application is a continuation in part of co-pending application Ser. No. 10/424,321, filed Apr. 23, 2003 by Todd Potter and entitled Implement Mounting Fixture.

### BACKGROUND OF THE INVENTION

1. Field of the Invention

The present invention relates to the field of implement-mounting fixtures.

2. Background of the Prior Art

Implements, of which farm implements are one example, are used to plow, plant crops, haul materials, and perform a variety of other useful tasks. A work machine carries, deploys, and sometimes powers the implement. Trucks, tractors, all-terrain vehicles (ATVs), maintenance vehicles, and the like are examples of work machines available that typically use implements.

An implement-mounting device is a structure forming a part of an implement that allows the implement to be mounted for use on a work machine.

A work machine is usually supplied with a structure called an implement attachment unit compatible with implement-mounting devices. This allows a variety of implements to be mounted on a work machine in a similar way. An implement attachment unit and a compatible implement-mounting device will be collectively referred to hereafter as a mounting interface.

The square tunnel hitch receiver for pulling trailers and other wheeled implements is a type of implement attachment unit that is now relatively standardized. A bracket attaches a square box beam to the rear or front of the work machine approximately parallel to the work machine centerline. A square hitch bar sized to fit closely within the tunnel has a flat, horizontal plate that projects from the end of the square bar. Aligned holes in the box beam and hitch bar allow a pin to strongly hold the bar in the tunnel. Removing the pin allows hitch bar removal to prevent the hitch bar from damaging other vehicles, and allows replacement by other hitch bars. The standard trailer hitch attaches to a trailer ball bolted through a vertical hole in the plate.

The square tunnel hitch receiver is suitable for pulling trailers and other wheeled implements but is usually unsuitable for other types of implements. For example, many types of implements, such a scrapers, mowers, etc. must be lifted from the ground during use and transporting.

A problem with many prior art mounting interfaces that can attach non-trailer type implements to work machines is that they often are unique or proprietary. This results in an implement-mounting device compatible with one type of work machine, but incompatible with other work machines. Other mounting interfaces require bolting at multiple points to attach an implement to the work machine, which is inconvenient and time-consuming.

The three-point hitch is an existing design for a mounting interface. The implement attachment unit of a three-point hitch comprises a central upper arm carried on to the work machine and two lower outboard arms. The upper arm attaches to an upper hitch point forming a part of the implement-mounting device. The two lower arms attach to two lower outboard points on the implement forming a further part of the implement-mounting device.

Typically, the two lower arms are powered to rotate upwards to lift the implement away from the ground. Gravity lowers the implement to ride across the ground when the two lower arms are rotated downward. Where necessary to properly operate an implement such as an aerator or scraper, the lower arms can be powered to force the implement into the ground as well. The upper arm prevents the implement from tilting forward or backward onto the ground when lifted by the lower arms.

The three-point hitch has been in use for 60 years for farm tractors, and has become a de facto standard for tractor mounting interfaces. A detached implement is attached to a tractor having a compatible three-point hitch type implement attachment unit by attaching the three bars of the implement attachment unit to the implement-mounting device on the implement.

Of course, the implement attachment unit of a three-point hitch must be compatible with the implement-mounting device of an implement, to mount that implement. Further, many different types of three-point hitch implement interfaces exist that are incompatible with each other. Thus, one problem with existing three-point hitches as well as other mounting interfaces, is that of incompatibility among manufacturers' product lines.

### SUMMARY OF THE INVENTION

An implement support structure is designed for attachment to a work machine having a hitch receiver with a tunnel for receiving a hitch bar. Since most work machines have a tunnel-type hitch receiver, the support structure can be mounted on the work machine. The support structure has a frame having a forward-facing side and a rear-facing side.

The implement support structure includes an implement attachment unit mounted on the frame to project to the rear. A hitch bar is attached to the frame and projects forward. The hitch bar is sized and shaped to insert into a standard size hitch receiver tunnel. The implement support structure can mate with an implement-mounting device forming a part of an implement to allow the work machine to support and transport the implement.

In a preferred embodiment, a three-point hitch type of implement attachment unit is mounted on the frame. Any implement having a compatible implement-mounting device can be mounted on the implement attachment unit.

For implements that are too heavy for a typical tunnel-type hitch receiver, a brace bar may be attached between a part of a work machine chassis and the implement support structure frame. Preferably the brace bar is attached to the implement support structure frame relatively far from the hitch bar.

### BRIEF DESCRIPTION OF THE DRAWINGS

FIG. 1 is a perspective view of a first embodiment of the present invention.

FIG. 1a is a perspective view of a second embodiment of the hitch bar of FIG. 1.

FIG. 2 is a perspective view of a second embodiment of the present invention.

FIG. 3 is a perspective view of a third embodiment of the present invention.

### DETAILED DESCRIPTION OF THE INVENTION

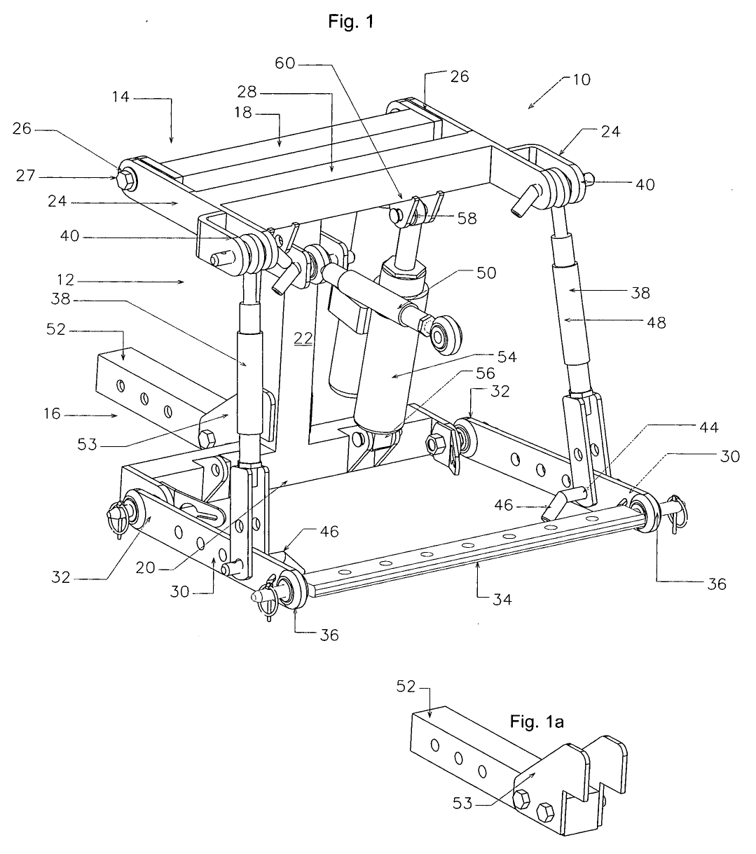

FIG. 1 illustrates a first embodiment of an implement attachment unit 10 for mounting an implement to a work machine having a conventional hitch receiver with a tunnel into which a hitch bar may be slipped.

The implement attachment unit 10 has a frame 12 having a forward-facing side generally facing the viewer, an oppositely directed rear-facing side, an upper or top portion 14 and a lower or bottom portion 16. The frame 12 has an upright member 22 that connects to an upper crossbar 18 in the upper portion 14 of the frame 12 and a lower crossbar 20 in the lower portion 16 of the frame 12. The upper crossbar 18 and lower crossbar 20 are generally parallel to each other and perpendicular to the upright member 22.

A pair of upper lift arms 24 extend from the upper portion 14 of the frame 12. The upper lift arms 24 each have a first end 26 pivotally connected by cap screw 27 to the upper portion 14 of the frame 12. The upper lift arms 24 are connected to opposing sides of the upper portion 14 of the frame 12. The upper lift arms 24 extend outwardly from the frame 12, generally parallel to one another.

A transverse beam 28 extends between the upper lift arms 24. The transverse beam 28 is connected to the upper lift arms 24 at a position spaced between the first end 26 and second end 40. The transverse beam 28 is fixedly connected to each of the upper lift arms 24 such that a force applied to the transverse beam 28 will cause each of the upper lift arms 24 to pivot about the respective first end 26.

A pair of lower lift arms 30 extend from a lower portion 16 of the frame 12. The lower lift arms 30 have a first end 32 pivotally connected to opposing sides of the lower portion 16 of the frame 12. The lower lift arms 30 extend outwardly from the lower portion 16 of the frame 12, generally parallel to each other. An implement 34 may be positioned between the outwardly extending second ends 36 of each of the lower lift arms 30.

An adjustable lift arm 38 extends from each of the upper lift arms 24 to a corresponding lower lift arm 30. The adjustable lift arms 38 are pivotally connected to a second, outwardly extending end 40 of the upper lift arms 24. The adjustable lift arms 38 are adjustably connectable to the lower lift arms 30. The lower lift arms 30 have a series of apertures 42 along a length of the lower lift arm 30. The adjustable lift arms 38 have a mating aperture 44 that is selectively alignable with any of the series of apertures 42 on the lower lift arm 30. The adjustable lift arms 38 are connected to the lower lift arms 30 by extending a pin 46 through the mating aperture 44 and corresponding aperture 42 of the lower lift arms 30. The body 48 of the adjustable lift arms 38 may include a ball swivel and clevis.

A link arm 50 is pivotally connected to the frame 12, and extends therefrom for linking to an implement. The link arm 50 is able to extend generally outwardly in the direction of the upper lift arms 24 and lower lift arms 30. The link arm 50 may pivot within a range extending from the lower portion 16 of the frame 12 to an upper portion 14 of the frame 12.

A hitch bar 52 very similar to a conventional hitch bar for carrying a hitch ball, extends from and is securely bolted to a bracket 53 welded to the lower portion 16 of the frame 12. This attachment allows replacing hitch bar 52 with another of a different size. Fitting 52 projects in the direction opposite that in which the upper lift arms 24 and lower lift arms 30 extend. Fitting 52 may be tubular as shown in FIG. 1 or a solid bar 52 as shown in FIG. 1a.

The implement-mounting fixture 10 is mounted on the work machine by inserting the fitting 52 into the tunnel of a conventional hitch receiver (not shown) on the work machine. A fastening pin is used to retain fitting 52 within the receiver tunnel.

The fitting 52 allows the implement-mounting fixture 10 to mount to the work machine at a single point, to be mounted to a wide variety of work machines, and to be mounted on either the front or rear of the work machines. The fitting 52 may be a Class II 2 in. by 2 in. (5.08 cm.) square, hollow, hitch bar. Additional components may include a Class I 1.25 in. by 1.25 in. (3.2 cm.) solid hitch bar. A pair of 3/8 in. (0.95 cm.) spacers can adapt a 2 in. by 2 in. hitch receiver tunnel to accept a Class I hitch bar.

A hydraulic cylinder 54 extends from the frame 12 to the transverse beam 28. The hydraulic cylinder 54 has a first end 56 connected to the lower portion 16 of the frame 12. The hydraulic cylinder 54 has a second end 58 connected to the transverse beam 28. A connecting member 60 connects the hydraulic cylinder 54 to the transverse beam 28. The connecting member 60 may include a bracket, or other such mechanical connection. The hydraulic cylinder 54 is selectively positionable on the frame 12. It is contemplated that when the implement-mounting fixture 10 is mounted on a work machine the hydraulic cylinder 54 can positioned on a side of the frame 12 opposite an exhaust system of the work machine.

The use of hydraulics provides a lifting and downward force in operation. The hydraulic cylinder 54 may provide a predetermined force, either generally upwardly or generally downwardly upon the transverse beam 28, causing the upper lift arms 24 to pivot about the upper portion 14 of the frame. This force results in a corresponding translation of force to the lower lift arms 30 via the adjustable lift arms 38 connected thereto.

The implement of course applies substantial cantilevered forces to the hitch bar receiver. On occasion, the weight or the downward force created by the implement to be mounted on fixture 10 will exceed the safe working cantilever load for a typical hitch receiver.

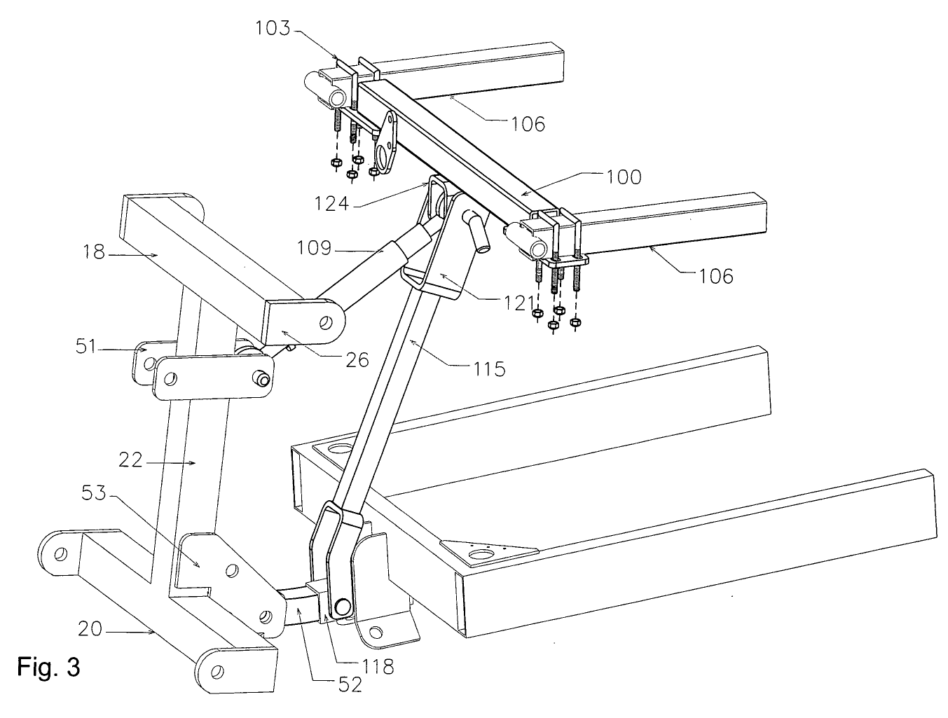

FIG. 3 shows a preferred solution to this problem. Relevant parts of implement attachment unit 10 are shown in phantom. Brace bars 109 and 115 provide added strength to the mounting for implement attachment unit 10. Brace bars 109 and 115 are attached at a first end of each by a pin to a bracket 124 welded to a cross link 100. Cross link 100 is attached to existing parts 106 of a work machine chassis that serve as brace points. In FIG. 3, this attachment is shown as two pairs of U-bolts 103, but can take a variety of forms that a skilled technician can easily develop. The actual shape and size of cross link 100 can also vary depending on the particular work machine involved.

A second end of brace bar 109 can be attached by any convenient means to upright member 22 of implement attachment unit 10. FIG. 3 shows a simple clamp 51 on upright member 22 that also serves as the attachment point for upper link 50. Generally, brace bar 109 provides better support for implement attachment unit 109 when mounted near the top of upright member 22, and relatively far above hitch bar 52.

Some embodiments may find that a brace bar 109 of variable length is convenient. The variable length may arise from a length of threaded rod in a turnbuckle arrangement as shown for brace bar 109.

The second brace bar 115 may also have its first end attached to bracket 124. The second end of brace bar 115 may attach to a hitch receiver tunnel 118 to strengthen the mounting on the work machine.

Brace bar 109 converts much of the cantilever loading on fitting 52 and the receiver tunnel 118 to shear and axial loading on these components, which substantially reduces the stress on them. Brace bar 115 strengthens the attachment between the work machine chassis and tunnel 118. In some cases, only one or the other of brace bars 109 and 115 are needed.

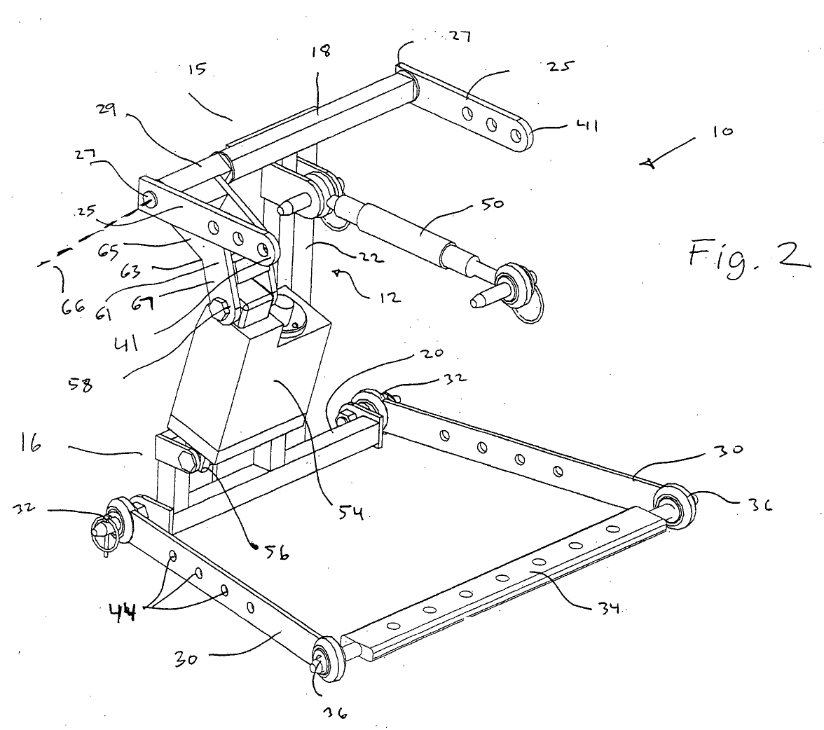

FIG. 2 illustrates a second embodiment of the present invention of an implement attachment unit for mounting an implement to a work machine.

The implement attachment unit 10 has a frame 12 having an upper portion 15 and a lower portion 16. A transverse beam 29 extends through the upper portion 15 of the frame 12. The transverse beam 29 defines an axis 66 about which the transverse beam 29 is able to rotate while being maintained within the upper portion 15 of the frame 12.

A pair of upper lift arms 25 are connected to opposing ends of the transverse beam 29. The pair of upper lift arms 25 have a first end 27 fixedly connected to the transverse beam 29 such that when the transverse beam 29 is rotated about the axis 66 the pair of upper lift arms 25 will likewise rotate.

A connecting member 61 extends from the transverse beam 29, perpendicular to the axis 66. The connecting member 61 has an angle point 63 such that it extends outwardly from the transverse beam 29 for a predetermined distance and then angles for a predetermined distance, forming a perpendicular section 65, and an angled section 67.

A hydraulic cylinder 54 extends from the frame 12 to the transverse beam 29. The hydraulic cylinder 54 has a first end 56 connected to the lower portion 16 of the frame 12. The hydraulic cylinder 54 has a second end 58 connected to the transverse beam 29, via the connecting member 61. The second end 58 of the hydraulic cylinder 54 is connected to the angled section 67 of the connecting member 61.

The hydraulic cylinder 54 may provide a predetermined force, either generally upwardly or generally downwardly upon the connecting member 61, causing the corresponding rotation of the transverse beam 29. The rotation of the transverse beam 29 causes the upper lift arms 25 to rotate with respect to the upper portion 15 of the frame.

As discussed with reference to FIG. 1, the application of a force upon the upper lift arms 25 results in a corresponding translation of force applied to the lower lift arms 30 via the adjustable lift arms 38 connected thereto.

The embodiment of FIG. 2 has a pair of lower lift arms 30 extending from the lower portion 16 of the frame 12, and a pair of adjustable lift arms 38 extending between the upper lift arms 25 and lower lift arms 30. A lift arm 50 is pivotally connected to the frame 12. A hitch tube 52 is connected to the opposite side of the frame 12. These elements are described in detail with reference to FIG. 1.

1. An implement support structure for mounting on a work machine having a hitch receiver with a tunnel for receiving a hitch bar, comprising:
a) a frame having a forward-facing side, a rear-facing side, a top, and a bottom;
b) an implement attachment unit mounted on the frame to extend to the rear, for mating with the implement-mounting device of an implement; and
c) a hitch bar attached to the frame to project forward, for inserting into the hitch receiver tunnel.

2. The implement support structure according to claim 1 wherein the hitch bar comprises a tubular shaft attached near the frame bottom.

3. The implement support structure according to claim 1 wherein the hitch bar comprises a solid bar attached near the frame bottom.

4. The implement support structure according to claim 1 wherein the work machine has a chassis, and including a first brace bar mounted on the frame, for attaching to a brace point on the work machine chassis.

5. The implement support structure according to claim 4, wherein the first brace bar is attached to the frame near the frame top.

6. The implement support structure according to claim 5 including a second brace bar attached to the chassis.

7. The implement support structure according to claim 4 wherein the implement attachment unit is a three point hitch.

8. The implement support structure according to claim 7 wherein the first brace bar is attached to at least one of the frame and the chassis by a clamp.

9. The implement support structure according to claim 8 wherein the hitch bar comprises a solid bar attached near the frame bottom and adapted to fit within a hitch receiver tunnel.
